(19) United States
(12) Patent Application Publication
(10) Pub. No.: US 2016/0306677 A1
(43) Pub. Date: Oct. 20, 2016

(54) Automatic Analytical Cloud Scaling of Hardware Using Resource Sub-Cloud

(71) Applicant: GLOBALFOUNDRIES INC., GRAND CAYMAN (KY)

(72) Inventors: Kalpesh Hira, Austin, TX (US); Jeffrey R. Hoy, Southern Pines, NC (US); Ivan M. Milman, Austin, TX (US)

(21) Appl. No.: 14/685,736

(22) Filed: Apr. 14, 2015

(51) Int. Cl. G06F 9/50

(52) U.S. Cl. CPC G06F 9/5083; G06F 9/5011

(57) ABSTRACT

Mechanisms are provided, in a data processing system comprising a primary system-on-a-chip (SOC) and a pool of SOCs, for processing a workload. The data processing system receives a cloud computing workload submitted and allocates the cloud computing workload to the primary SOC. An analytics monitor of the data processing system monitors a bus of the data processing system for at least one first signal indicative of an overloaded condition of the primary SOC. A Power, Reset, and Clocking (PRC) hardware block powers-up one or more auxiliary SOCs in the pool of SOCs in response to the analytics monitor detecting the at least one first signal. The workload is then distributed across the primary SOC and the one or more auxiliary SOCs in response to powering-up the one or more SOCs. The workload is then executed by the primary SOC and the one or more SOCs.

### BACKGROUND

The present application relates generally to an improved data processing apparatus and method and more specifically to mechanisms for performing analytical cloud scaling of hardware using a resource sub-cloud.

Cloud computing is a recently emerging technology that involves deploying groups of remote servers and software networks that allow centralized data storage and online access to computer services or resources. Cloud computing relies on sharing of resources to achieve coherence and economies of scale, similar to a public utility (such as the electricity grid) over a network. At the foundation of cloud computing is the broader concept of converged infrastructure and shared services.

Cloud computing, or simply “the cloud”, is based on the concept of maximizing the effectiveness of shared resources by providing a pool of shared computing systems, storage systems, or the like, which can be apportioned out to users and applications for use as needed. Cloud resources are usually not only shared by multiple users but are also dynamically reallocated on-demand. For example, a cloud computing facility that serves European users during European business hours with a specific application (e.g., electronic mail) may reallocate the same resources to serve North American users during North America's business hours with a different application (e.g., a web server). This approach maximizes the use of computing resources taking into account the varying demand of different users. With cloud computing, multiple users can access a single server to retrieve and update their data without purchasing licenses for different applications.

### SUMMARY

In one illustrative embodiment, a method, in a data processing system comprising a primary system-on-a-chip (SOC) and a pool of SOCs, for processing a workload. The method comprises receiving, by the data processing system, a cloud computing workload submitted to a cloud computing system with which the data processing system is associated. The method further comprises allocating, by the data processing system, the cloud computing workload to the primary SOC and monitoring, by an analytics monitor of the data processing system, a bus of the data processing system for at least one first signal indicative of an overloaded condition of the primary SOC. The method also comprises powering-up, by a Power, Reset, and Clocking (PRC) hardware block, one or more auxiliary SOCs in the pool of SOCs in response to the analytics monitor detecting the at least one first signal. In addition, the method comprises distributing the workload across the primary SOC and the one or more auxiliary SOCs in response to powering-up the one or more SOCs and executing the workload by the primary SOC and the one or more SOCs.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise a primary SOC, a pool of SOCs, an analytics monitor, a PRC hardware block, and an interconnect bus. The apparatus/system may be configured to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a cloud computing node in accordance with one illustrative embodiment;

FIG. 2 is an example block diagram of a cloud computing environment in accordance with one illustrative embodiment;

FIG. 3 is an example diagram of a set of functional abstraction layers provided by a cloud computing environment in accordance with one illustrative embodiment;

FIG. 4 is an example block diagram illustrating the primary operational components of a hybrid cloud computing system in accordance with one illustrative embodiment;

FIG. 5 is an example block diagram of an SOC that focuses on an example implementation of a performance monitor of the SOC in accordance with one illustrative embodiment;

FIGS. 6A-6B illustrate an example timing diagram for a pipelined back-to-back read transfer showing the assertion of a PLB primary read request (PLB_RDPRIM) for which the analytics monitor of the illustrative embodiments monitors;

FIGS. 7A-7B illustrate an example timing diagram for a pipelined back-to-back write transfer showing the assertion of the PLB primary write request (PLB_WRPRIM) for which the analytics monitor of the illustrative embodiments monitors;

FIG. 8 illustrates an example timing diagram for a slave requested re-arbitration showing the assertion of a slave re-arbitration signal (S2_rearbitrate) for which the analytics monitor of the illustrative embodiments monitors;

FIG. 9 is a flowchart outlining an example operation for dynamically powering-up and powering-down SOCs from a SOC pool of a sub-cloud in a platform according to workload conditions of the platform in accordance with one illustrative embodiment; and

FIG. 10A-10D illustrate example scenarios of the dynamic powering-up and powering-down of SOCs in a pool of SOCs to facilitate workload distribution in accordance with example illustrative embodiments.

### DETAILED DESCRIPTION

Cloud computing systems offer many advantages including the availability of short-term pooled hardware for “burst” scenarios. For example, a typical burst scenario may involve a retailer establishment's web site during the holiday shopping season where dynamic scaling may be enabled to trigger creation of/enabling additional systems to handle a temporary increase in user load. This creation of/enabling of additional systems may then be scaled back when the user load or demand for resources diminishes, e.g., after the holiday shopping season has concluded. Thus, an on-demand approach to computer resources is made available via cloud computing such that the amount of resources given to any requesting application, user, or the like, may be scaled up or down according to the requirements of the requester.

In many cases the computing systems themselves, which make up the cloud, also make use of dedicated hardware to accelerate particular workloads. For example, the computing systems may make use of a graphics processing unit (GPU) for graphics or vector processing and encryption devices for encryption/decryption operations. These devices are entirely separate from cloud pooling capabilities of the cloud system. That is, the computing system offers its processing capability and storage as a whole as part of the cloud system service offering, but the underlying hardware of the computing system itself is not part of this offering, although it assists the computing system with providing the processing capability and storage capability of the computing system in order to provide the cloud system service offerings. In other words, a user or application requesting cloud services cannot request specific use of a computing system's individual GPU or encryption devices but instead merely requests a certain amount of general processing capability or storage capability from the cloud system as a whole as a service. While these dedicated hardware devices are separate from the cloud pooling capabilities, they may be used to solve a similar problem to the burst scenario where a particular bottleneck is offloaded to dedicated hardware.

In highly demanding cloud-based systems there is an increasing need for a combination of these two solutions, i.e. a system that makes use of both cloud based system burst handling capabilities and an individual system's dedicated hardware. For example, in the burst scenario the retailer's web site may need to scale up for increased demand, but a bottleneck on the retailer's web site performance in handling traffic of the web site may be determined to be disproportionately coming from the encryption and decryption operations, whereas the backend systems may not require scaling to the same degree as the cloud system as a whole. Current cloud systems do not provide narrow burst capability like selective encryption/decryption offloading. Thus, there is a need for dedicated computing resources to scale for particular operations in a cloud computing environment.

The illustrative embodiments provide mechanisms that apply cloud-based pooling to hardware resources within a platform for offloading processing directed to detected software bottlenecks. That is, the illustrative embodiments create a cloud computing environment within a single platform, with multiple platforms providing a large scale cloud based system, i.e. there is a cloud of general purpose resources within a platform that itself is part of a larger networked cloud of platforms/computing systems. The general purpose resources may be configured, such as via installation of application specific images, for performing application-specific execution of workloads depending on the particular workloads that need to be offloaded to these resources.

The illustrative embodiments provide mechanisms for monitoring signaling and events occurring within the platform to determine when to modify the allocation of resources within the platform in a cloud-based manner to handle specific software bottlenecks. For example, the platform may be a computing system, such as a rack of computing resources coupled to one another via one or more buses, with the resources of the platform being a plurality of systems-on-a-chip (SOCs) which may be selectively enabled/disabled based on detected demands for particular types of software processing by the platform. This selective enablement/disablement of resources is performed in a transparent manner to the software-based applications utilizing the cloud services. The mechanisms of the illustrative embodiments may monitor the communication interface, e.g., signaling pins, of the SOCs to identify signals conveying information collected by a performance monitor of the SOCs and determining if these signals/information are indicative of events corresponding to an overloaded or underloaded condition of the SOCs. Based on this determination, dynamic powering-up or powering-down of SOCs may be performed so as to balance the number of powered-up SOCs with the workload being processed.

With the mechanisms of the illustrative embodiments, a workload may be submitted to a cloud system by a client computing device, an application running on a computing system of the cloud system, or the like, for processing by the platforms of the cloud system, where a platform may be any computing device or system, such as a server computing device, a blade server having a plurality of blade computing devices, a rack of servers or SOCs, or any other computing device or system whose overall capabilities may be pooled with other computing devices/systems to provide a cloud based service to one or more requesting client devices. The workload may be routed to a platform in the cloud system which then allocates the workload to a resource of the platform. For purposes of the following discussion, it will be assumed that this resource of the platform is a SOC of the platform, however the illustrative embodiments are not limited to such and any processing/storage resource may be used without departing from the spirit and scope of the illustrative embodiments.

A primary SOC of the platform becomes loaded with the workload. While the initial SOC that receives the workload is referred to as the “primary” SOC in this description, it should be appreciated that the primary SOC is one of many SOCs in the pool of SOCs which are generalized systems-on-a-chip that can be configured to perform any desired processing of workloads. Thus, one SOC in the pool is no different from any other SOC in the pool until it is powered up and configured to execute a particular workload. Hence, the “primary” SOC is only one SOC, in the pool of SOCs, which first receives the workload sent to the platform, or sent by an application executing on the platform, for processing. The primary SOC may be maintained in a continuously powered-on state such that it is not powered-down or placed in a low power state like the other SOCs in the SOC pool. This is to ensure that at least one SOC in the pool of SOCs is always available to take an assigned workload when a workload is sent to the platform for processing.

In one illustrative embodiment, for example, the workload may be a security workload, such as secure socket layer (SSL) processing of data communications between a client computing device and a particular application running on the cloud system. In response to receiving the workload, the primary SOC may be configured with a system image for performing SSL processing, if not already configured to do so, and the workload may be sent to the primary SOC for processing. An analytics monitor of the platform monitors the bus traffic of the platform to determine whether the primary SOC is reaching its maximum capacity for handling the workload while the primary SOC executes the workload. For example, burst traffic may quickly cause the primary SOC to reach, or at least approach, its maximum capacity for handling the application specific workload and this may be detected by the analytics monitor that monitors the traffic across the interconnect bus of the platform. One or more thresholds may be utilized by the analytics monitor to determine which situation is present.

The monitoring of the bus traffic by the analytics monitor may comprise monitoring the communication interface of the powered-up SOCs (initially just the primary SOC) to determine if particular signals, patterns of signals, or the data/information conveyed by the signals is indicative of events corresponding to overloaded or underloaded conditions of the SOCs, e.g., monitoring the pins of the SOCs for these signals, patterns of signals, of data/information conveyed in these signals. In one illustrative embodiment, the analytics monitor monitors general purpose input/output (GPIO) pins and interrupt pins of the SOCs that are powered-up. Thus, for example, the GPIO pins of the SOCs may be used to communicate, via signals, data recorded by an internal performance monitor of the SOC. Interrupt events that occur may be communicated outside of the SOC via the interrupt pins which are also monitored by the analytics monitor. Various types of recorded data or interrupt events may be indicative of overloaded or underloaded conditions of the SOC, which the analytics monitor is configured to identify in the manner described hereafter.

If the analytics monitor determines that the SOC is reaching or has reached its maximum capacity, i.e. is overloaded, the analytics monitor informs a Power, Reset and Clocking (PRC) hardware block of the situation which causes the PRC hardware block to power-up one or more additional auxiliary SOCs that are part of a plurality of SOCs residing in a pooled hardware “sub-cloud” of the platform, where the term “sub-cloud” is used to distinguish the cloud within the platform from the cloud comprising multiple platforms. It should be appreciated that these SOCs may reside in a powered-off, or low power consumption, state until they are powered-up by the PRC hardware block in response to the analytics monitor determining that the primary SOC is reaching (within a predetermined tolerance) or has reached its maximum capacity. Moreover, as discussed hereafter, these SOCs may be returned to a powered-off, or low power consumption, state once the analytics monitor determines that the workload has been reduced to a level where the SOCs are no longer necessary for handling the workload, e.g., an underloaded state of the SOCs.

Having powered-up the one or more auxiliary SOCs, the auxiliary SOCs may also be configured with an appropriate system/application image for performing the processing of the workload, if not already configured to do so, and the workload is then offloaded from the primary SOC and distributed to the auxiliary SOCs, such as via a Peripheral Component Interconnect Express (PCIE) bus and interface on each of the SOCs, or the other communications pathway between the SOCs. This offloading and distribution may involve using a balancing algorithm or other technique for distributing the workload evenly across the power-up SOCs or otherwise distributing the workload to achieve as close to an optimal distribution of the workload as possible. While multiple SOCs may be operating on the workloads that are being handled by the platform, coherency of the data is maintained through the use of a common shared memory, e.g., a flash memory or the like.

The analytics monitor continues to monitor the bus traffic of the platform, e.g., the pins of the powered-up SOCs and the signals being transmitted across the bus from these pins, to identify conditions where there is an underloading of the platform, e.g., the workload is less than one or more predetermined thresholds. If an underloading condition is detected by the analytics monitor, the analytics monitor signals the PRC hardware block to divert the workload back to the primary SOC with subsequent scaling down and powering off, or placing in a low power consumption state, the auxiliary SOCs or a subset of the auxiliary SOCs. That is, in some embodiments, based on the amount of the underloading, a sub-set of the auxiliary SOCs that have been powered-on may be selected to be powered-down or placed in a low power consumption state while others of the auxiliary SOCs may remain in a powered-on state. In this way, a gradual scaling back of the auxiliary SOCs may be achieved based on the level of underloading detected by the analytics monitor.

Thus, through the mechanisms of the illustrative embodiments, a sub-cloud is provided within the platform which allows dynamic allocation/de-allocation of resources to application specific workloads. The particular resources that are allocated/de-allocated may be application specific resources, i.e. hardware and software that are specifically designed and provided to assist with a specific type of workload, e.g., security hardware for encryption/decryption within the platform may be specifically allocated/de-allocated for encryption/decryption workloads. In some illustrative embodiments, these resources may be generic resources that are specifically configured on-demand for particular workloads, e.g., a graphics processing unit (GPU) that is reconfigured by way of a kernel provided in the GPU for processing a different type of workload from the graphics processing the GPU is typically used for, such as a SSL kernel or the like. In some illustrative embodiments, as described herein, the resources are general purpose SOCs that are configured dynamically for performing different types of execution on different types of workloads or which have internal cores of various types that are already configured to execute certain types of workloads, e.g., a cryptographic core, a graphics processing core, or the like.

Before beginning the discussion of the various aspects of the illustrative embodiments in more detail, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

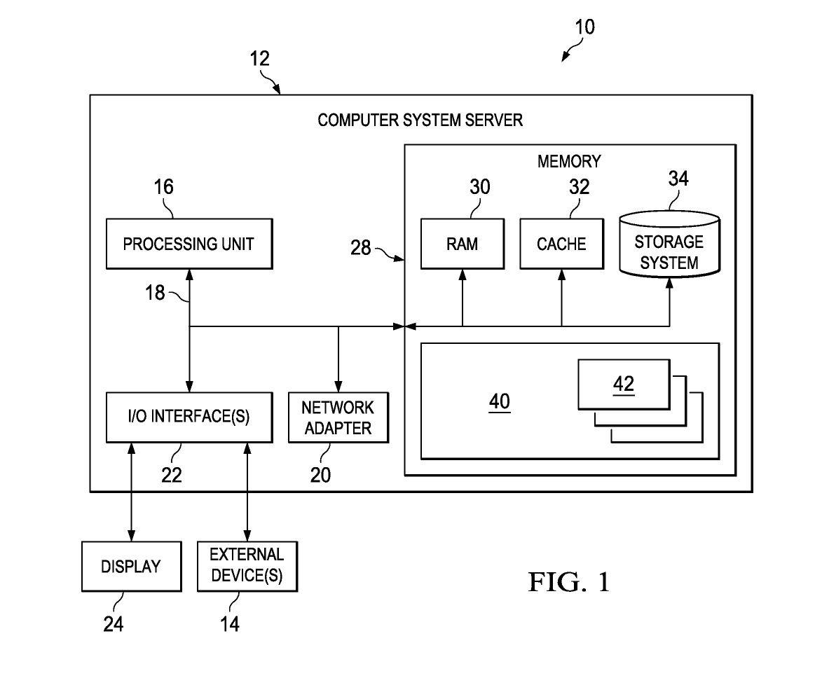

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. In one illustrative embodiment, the bus 18 may also comprise a processor local bus (PLB) such as International Business Machines (IBM) Corporation 128-bit processor local bus 4 (PLB4) version 4.7, available from IBM Corporation of Armonk, N.Y., as an example.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

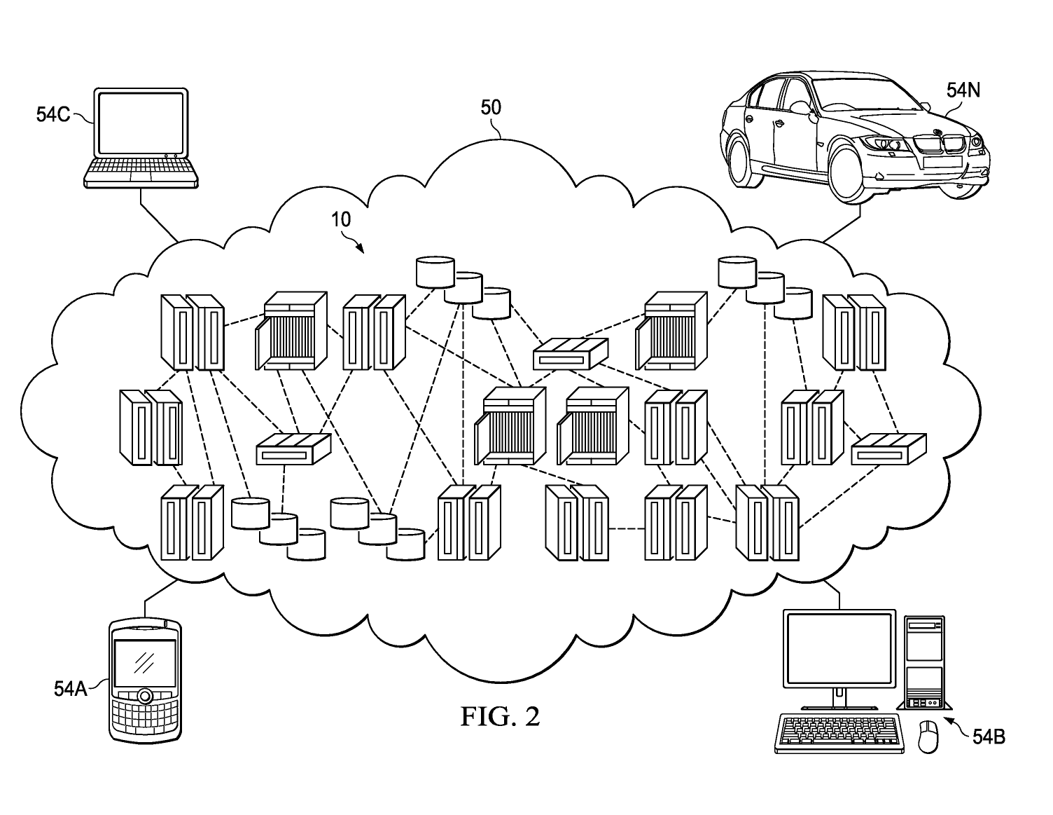

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

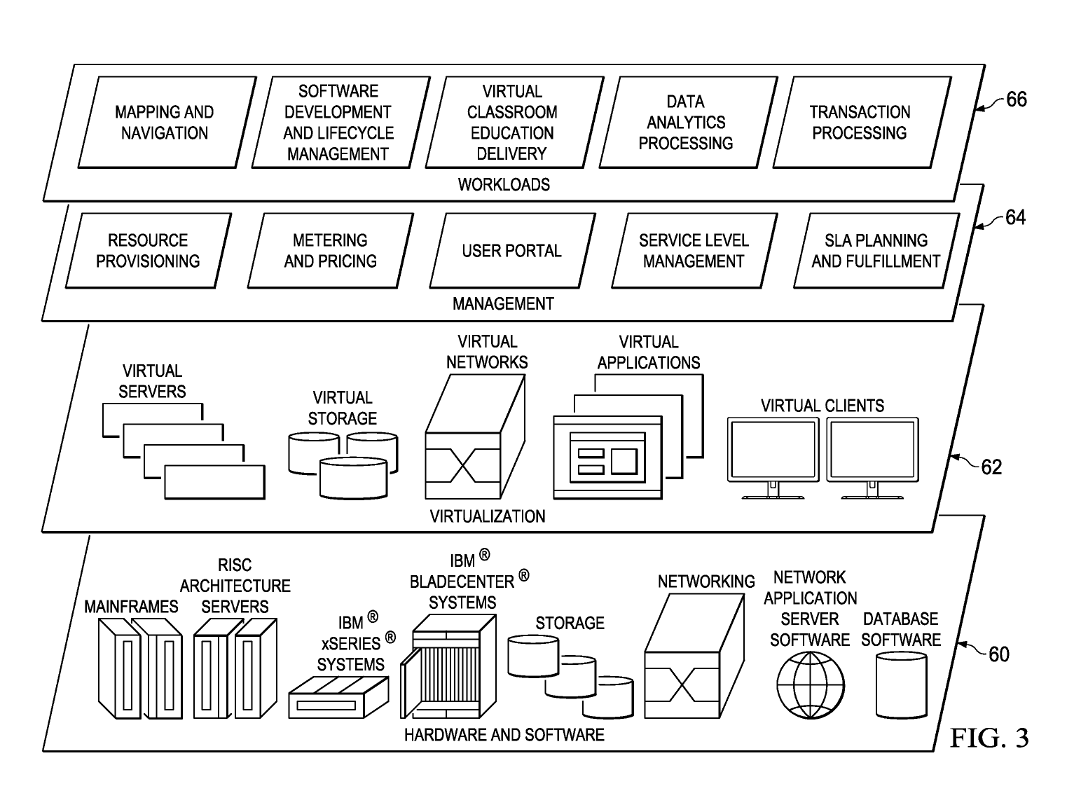

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, RISC (Reduced Instruction Set Computer) architecture based servers, blade servers, storage devices, and networks and networking components. In some embodiments, software components include network application server software and database software.

Virtualization layer 62 provides an abstraction layer from which virtual entities may be provided. Examples of virtual entities that may be provided by the virtualization layer 62 include, but are not limited to, virtual servers, virtual storage, virtual networks, including virtual private networks, virtual applications and operating systems, and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include, but are not limited to, mapping and navigation, software development and lifecycle management, virtual classroom education delivery, data analytics processing, and website hosting and transaction processing.

As noted above, the cloud computing environment 50 may comprise many computer systems/servers 12 which together as a whole provide the cloud services and functionality previously described above. Local computing devices of cloud consumers may be utilized by the cloud consumers to submit workloads to the cloud computing environment 50 for processing, e.g., a user of a local computing device attempts to access a web site hosted by the cloud computing environment 50 for purposes of engaging in a commercial transaction. The web site owner enlists and contracts with the cloud computing environment 50 provider to host the web site and provide the cloud computing environment 50 services to the web site owner for such hosting, e.g., transaction processing services, payment services, storage services, etc. The web site owner is not able to control the infrastructure or access the infrastructure of the cloud computing environment 50 directly, but instead requests or contracts with the cloud computing environment 50 provider to provide certain services and level of service, leaving it up to the cloud computing environment 50 to determine how that service and level of service are provided, e.g., allocating a certain amount of storage space to the web site owner, allocating a certain amount of bandwidth and processor resources, etc.

As mentioned above, while cloud computing environments, such as cloud computing environment 50, allow for the pooling of computing systems/servers as a whole for purposes of providing cloud services, such environments do not allow for the fine grained pooling and allocation/deallocation of resources within the individual computing systems/servers for handling specific types of workloads. That is, for example, assume a cloud computing environment comprises a plurality of server computers and hosts a retailer's online web site that takes orders from consumers and processes transactions. During certain times of the year, traffic to the web site may dramatically increase, i.e. there may be a burst of traffic, resulting in a larger amount of processing of commercial transactions necessary. In other times of the year, the demand on the web site may be considerably less. This burst of traffic may cause bottlenecks to occur in the processing of the commercial transactions, e.g., while the processors of the computing systems/servers may be fully capable of handling the application based processing of the commercial transactions, lower level security operations, e.g., Secure Socket Layer (SSL) processing, may not and may result in a bottleneck.

In general, the cloud computing environment may detect the increase in traffic and allocate more computing systems/servers to the handling of the web site's traffic. However, this allocation of computing systems/servers is done on a macro level, meaning that the allocation is not based on any detected reason for the processing bottlenecks encountered due to the burst traffic. Thus, while the allocation of more computing systems/servers may be appropriate in handling the application processing of additional traffic, this may be inefficient for handling the actual bottleneck in processing the commercial transactions. Hence a more targeted, or workload specific, allocation of resources is desirable. Moreover, this allocation of resources may be performed within a platform (e.g., computing system/server) with regard to a sub-cloud of resources of the single platform. As a result, a hybrid of both macro allocation at the cloud computing environment, through the allocation of one or more additional platforms, and micro allocation within a single platform of additional resources based on a detected reason for a bottleneck in processing, is achieved.

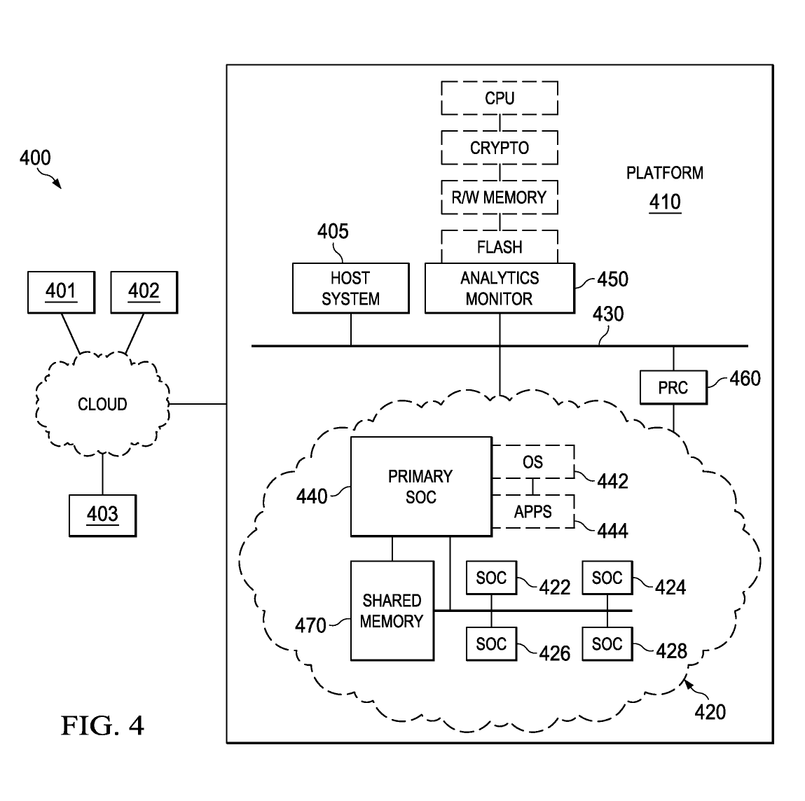

FIG. 4 is an example block diagram illustrating the primary operational components of a hybrid cloud computing system in accordance with one illustrative embodiment. As shown in FIG. 4, with the mechanisms of the illustrative embodiments, a platform 410 that is part of a cloud computing environment 400 is provided with a pool 420 of general purpose systems-on-a-chip (SOCs) 422-428 and 440 that may be allocated/deallocated for executing workloads in response to detected events/data/signals, communicated by the powered-up SOCs 422-428 and 440 of the pool 420, on an interconnect bus 430 that is coupled to the SOCs 422-428 and 440. The SOCs 422-428 and 440 themselves have internal buses which connect the internal logic of the SOCs 422-428 and 440 and with which internal performance monitors (not shown) are coupled to the other logic of the SOCs 422-428 and 440 for purposes of monitoring the performance of the SOC 422-428 and 440. It is information from the performance monitors of the SOCs 422-428 and 440 that is communicated externally from the SOC 422-428 and 440 on the interconnect bus 430 which may then be monitored by an analytics monitor 450, as discussed hereafter.

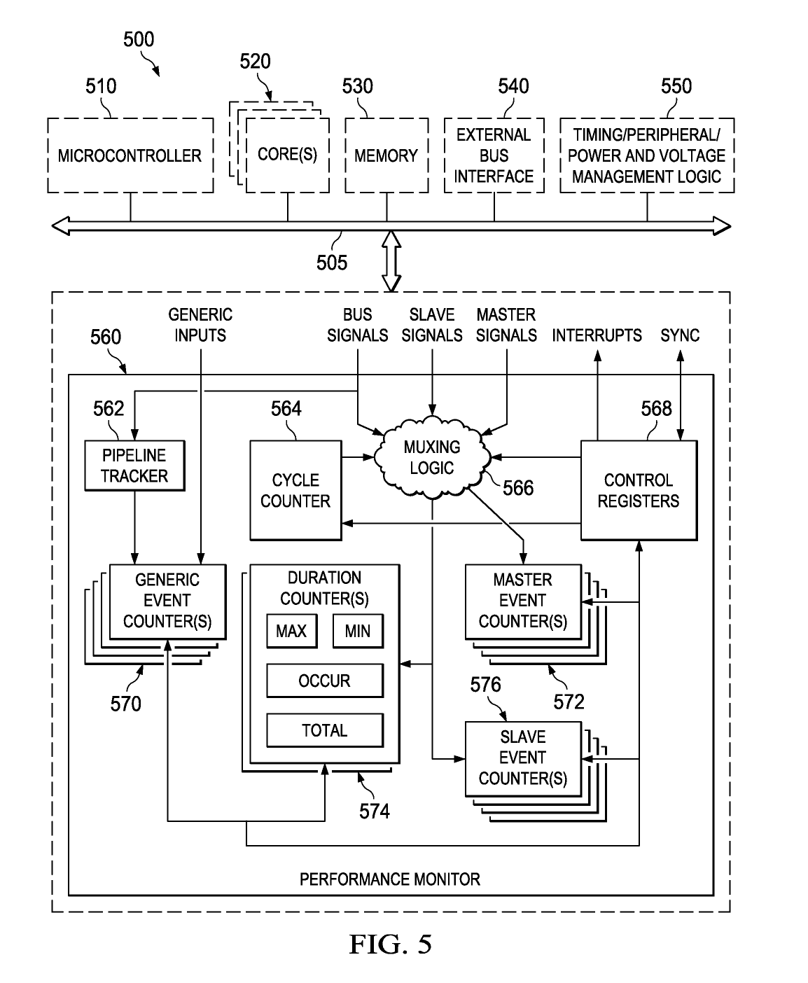

A SOC 422-428, 440 is an integrated circuit (IC) that integrates all components of a computer or other electronic system into a single chip. It may contain digital, analog, mixed-signal, and often radio-frequency functions all on a single chip substrate. A typical SOC 422-428, 440 consists of a microcontroller, microprocessor or digital signal processor (DSP) core, memory blocks including a selection of ROM, RAM, EEPROM and flash memory, timing sources including oscillators and phase-locked loops, peripherals including counter-timers, real-time timers and power-on reset generators, external interfaces, including industry standards such as Universal Serial Bus (USB), FireWire, Ethernet, or the like, analog interfaces including Analog to Digital Converters (ADCs) and Digital to Analog Converters (DACs), and voltage regulators and power management circuits. These elements are connected to one another via proprietary or industry-standard internal bus. Direct Memory Access (DMA) controllers may be used to route data directly between external interfaces and memory, thereby bypassing the processor core and increasing data throughput of the SOC. The SOCs 422-428 and 440 comprise performance monitors that comprise counters and other logic for monitoring the performance of the SOC 422-428, 440. Performance information may be output by the SOC 422-428 and 440 to the host system of the platform 410 via external interfaces that couple the SOC 422-428 and 440 to the interconnect bus 430, e.g., General Purpose Input/Output (GPIO) pins, interrupt pins, and the like. For purposes of clarity of the figure, the internal details of the SOCs 422-428, 440 are not explicitly shown in FIG. 4 however, an example of the performance monitor of an SOC will be described in greater detail hereafter with reference to FIG. 5.

A primary SOC 440 may be provided as part of pool 420 in the platform 410. The primary SOC 440 is similar to the other SOCs 422-428 in the pool 420 of SOCs 422-428 with one primary difference. Where the SOCs 422-428 of the pool 420 are placed in a powered-off or low-power consumption state when they are not actively being utilized to process workloads, the primary SOC 440 stays powered-up or active so that it is immediately available when a workload is received by the platform 410 for processing. Thus, the primary SOC 440 may be thought of as a first responder to workloads with the other SOCs 422-428 of the pool 420 providing the on-demand resources for handling workloads in response to detecting events, data, or signals of interest on the interconnect bus 430. The primary SOC 440 may be configured with the basic operating system 442 and applications 444 provided by the platform 410 as part of the cloud computing environment 400 so as to have the necessary logic to immediately process and respond to received workloads.

As mentioned above, the platform 410 is further provided with an analytics monitor 450 that monitors for certain events, signals, patterns of events/signals, or the like, occurring on the interconnect bus 430 of the platform 410, as sent by the SOCs 422-428, 440 via their external bus communication interfaces (e.g., pins), for example, which are indicative of a need to increase/decrease allocations of SOCs 422-428 in the pool 420 to workloads. The analytics monitor 450 is configured to monitor for certain events, data, signals, or patterns of events, data or signals, that are present on the interconnect bus 430 and, in response to detecting the presence of these events, data, or signals, may send commands to platform Power, Reset, and Clocking (PRC) hardware block 460 to cause the PRC hardware block 460 to power-on/power-off one or more of the SOCs 422-428 in the pool of SOCs 420.

The platform 410 further comprises a shared memory 470 that is shared by the primary SOC 440 and each of the SOCs 422-428 of the pool of SOCs 420. This shared memory 470 provides a central data store to ensure data coherency in the event that a workload is distributed across multiple SOCs 440 and 422-428, as discussed in greater detail hereafter. In one illustrative embodiment, this shared memory 470 is a flash memory, although other types of memories may be used without departing from the spirit and scope of the illustrative embodiments.

In operation, an application specific workload, such as IBM® DataPower® SSL handling, for example, is submitted to the platform 410 for processing, or is otherwise generated/initiated by applications or the operating system executing on the platform 410, for processing by the platform 410. The platform 410 itself may be engaged in providing the IBM® DataPower® functions with SSL handling being handled by the primary SOC 440 of the platform 410. IBM® DataPower® is a purpose-built security and integration platform for mobile, cloud, application programming interface (API), web, service-oriented architecture (SOA), and Business-to-Business (B2B) workloads. IBM® DataPower® enables one to rapidly expand the scope of information technology (IT) assets to new channels and use cases and reach customers, partners and employees. IBM® DataPower® helps quickly secure, integrate, control and optimize access to a range of workloads through a single, extensible, Demilitarized Zone (DMZ) ready gateway. It should be noted. that IBM® DataPower® and IBM® DataPower® SSL handling are only examples of workloads with which the mechanisms of the illustrative embodiments may be utilized. The workload submitted to the platform 410 or otherwise processed by the platform 410 may be any workload suitable to the particular implementation of the illustrative embodiments. The workload may be an entire application server, a portion of an application server that can be offloaded, a single operation, or the like.

In response to receiving or initiating execution of the workload on the platform 410, the primary SOC 440 is configured by the host system 405 of the platform 410 by installing an operating system image and application (if not already configured with such) in the SOC 440 for use in processing the particular workload, e.g., if the workload is a SSL handling workload, then the SOC 440 may be configured to process an SSL handling workload. The primary SOC 440 utilizes its own internal resources to process the workload. The analytics monitor 450 is configured to monitor the interconnect bus 430 of the platform 410 for predetermined signals, data, or events indicative of overloading and/or underloading of the SOC 440 and/or SOCs 422-428 of the SOC pool 420. In one illustrative embodiment, the analytics monitor 450 monitors the interconnect bus 430 for pipelining signals indicative of one or more of a processor usage condition, flash memory pipelining conditions, cryptographic or security pipeline conditions, or memory read/write pipelining conditions. These signals are sent by the SOCs 422-428, 440 when communicating with other elements of the platform 410, e.g., a flash memory controller, physical flash memory, or other components of the platform 410 coupled to the interconnect bus 430.

If the analytics monitor 450 identifies the pipelining signals as being present on the interconnect bus 430, then the analytics monitor 450 sends a signal or command to the PRC hardware block 460 indicating a need to power-up or power-down SOCs 422-428 in the SOC pool 420 for offloading of the workload to the SOCs 422-428 (overloaded condition) or returning the workload to the primary SOC 440 (underloading condition). For example, for memory read/write pipelining conditions, the mechanisms of the analytics monitor 450 may look for primary read request signals and primary write request signals which may be indicative of an overloaded loading condition and the need to offload computations to other SOCs 422-428. As another example, another event that may be looked for by the analytics monitor 450 include looking at the number of times a buffer or FIFO in a cryptographic engine of a SOC 422-428, 440 becomes full within a certain period of time. Other events may be detected by the analytics monitor 450 based on particular signals, patterns of signals, or data, that is communicated by the SOCs 422-428, 440 as indicative of the current state or condition of the SOCs 422-428, 440 that are powered-up and operating on the workload. The particular signals and data that are transmitted may be transmitted by the SOCs 422-428, 440 via their internal performance monitors and communication interfaces as discussed below.

In addition, the analytics monitor 450 may be configured to monitor for the assertion of a processor busy signal indicative that processors are busy and unable to process reads/writes. This would be indicative of a need to power-up additional SOCs 422-428 to assist in processing the workload to alleviate the busy condition of the processor.

Assuming that the analytics monitor 450 is monitoring the interconnect bus 430 and detects a predetermined condition (e.g., a signal or set of signals that correspond to a predetermined condition) indicative of an overloading of the primary SOC 440 by the workload, e.g., one or more of a processor usage condition, flash memory pipelining conditions, cryptographic or security pipeline conditions, or memory read/write pipelining conditions, the analytics monitor 450 sends a command/signal to the PRC hardware block 460 indicating the overloading of the primary SOC 440 and requesting powering-up of one or more SOCs 422-428 in the SOC pool 420. The analytics monitor 450 may further determine how many SOCs 422-428 need to be powered-up (or powered-down in the case of an underloading condition being detected).

The determination as to how many SOCs 422-428 need to be powered-up/down is dependent upon the nature of the particular workload and the overload/underload criteria. For example, assume that the workload is 512 Mega Bytes (MB) of data which must be compressed. The SOCs 422-428, 440 have, as part of their internal logic, a compression/decompression engine. Each such engine can compress only 128 MB at a time. The analytics monitor 450 may be configured with this knowledge of the limitations of the SOC compression/decompression engine in advance of the workload having been received and further is informed by the host system 405 of the size of the data to be compressed. As a result, the analytics monitor 450 may determine that the workload would be best distributed in a parallel manner and will distribute the workload across a sufficient number of SOCs 422-428, 440 to perform the requested workload in parallel with maximum efficiency, e.g., distribute the workload across 4 SOCs (128 MB×4=512 MB), if available by powering-up the correct number of SOCs 422-428 to assist the primary SOC 440 in performing the workload.

In situations where the analytics monitor 450 does not know the specific configuration and processing limitations of the SOC hardware 422-428, 440 a priori, the analytics monitor 450 relies on analytical data gathered from the loading of workloads on the SOCs 422-428, 440. In such a situation, the performance monitors of the SOCs 422-428, 440 detect that the read pipeline depth in the compression/decompression engine has reached its maximum and that a particular busy signal has been asserted multiple times within a given time window. As a result, an overload condition is identified by the analytics monitor 450 which then signals the PRC hardware block 460 of the need to power-up another SOC 422-428 from the pool 420. The workload is then distributed over the primary SOC 440 and the additional SOC, e.g., SOC 422. If the second SOC 422 also records the same loading condition which is then detected by the analytics monitor 450, a third SOC, e.g., SOC 424, is powered-up by the PRC hardware block 460, and so on until the overloaded loading condition is no longer detected. If the overloaded loading condition is no longer present after powering-up the third SOC 424, but is still detected in the second and first SOCs 422 and 440, this is an indication not to power-down the third SOC 424. However, if the overloaded loading condition abates in the second and third SOC 422, 424, this is an indication that the third SOC 424 can be powered-down and the workload shifted back to the remaining powered-up SOCs 422, 440. There are only examples of ways in which to determine how many SOCs 422-428 of the pool 420 to power-up/down in response to a detected overloaded/underloaded condition.

In response to the command/signaling from the analytics monitor 450, the PRC hardware block 460 then controls the power, reset, and clocking of the SOCs 422-428 in the pool of SOCs 420 to thereby power-up/power-down a corresponding number of the SOCs 422-428 to offload the processing of the workload to the powered-up SOCs 422-428. For example, consider an embodiment in which devices have 5 power states, D0, D1, D2, D3hot, and D3cold (see Wikipedia article on “Advanced Configuration and Power Interface” as an example). Considering three of these states, i.e. D0, D3hot, and D3cold, D0 refers to the device (SOC) being fully on, D3cold refers to the SOC being off and no power being provided, and D3hot refers to the SOC being off but with power being supplied to the SOC. SOCs are in a voltage island with only minimal power asserted to them such that all non-used SOCs 422-428 in the pool 420 are in a low power, quiescent state, i.e. D3hot state. The SOCs 422-428, when in this state, have their pin, STANDBY, asserted. This means that they are in a standby mode.

When the analytics monitor 450 determines there is an overload of another SOC, e.g., primary SOC 440, the analytics monitor 450 instructs the PRC hardware block 460 to power-up a SOC 422-428. The analytics monitor 450 may instruct the PRC hardware block 460 by sending a dedicated interrupt signal, for example, to the PRC hardware block 460. The PRC hardware block 460 comprises interrupt detection logic that detects the interrupt signal from the analytics monitor 450 and then powers on one or more of the SOCs 422-428 (depending on whether the signal indicates a number of SOCs to power-up). This may be done, for example, by de-asserting a STANDBY READY signal to the SOC(s) 422-428 that are to be powered-up, and asserting reset and clock signals to the SOC(s) 422-428 that are to be powered-up to thereby bring them out of their standby state. Thus, the SOC(s) 422-428, e.g., SOC 422, goes from a D3hot state to D0 (fully powered) state.

When the SOCs 422-428 power-up they have a boot vector for the program stack, which is a predetermined section of the program stack stored in the shared memory 470 (e.g., flash memory). The program stack contains details of what workload the powered-up SOC should operate on. The workload can be routed in various ways to the newly powered auxiliary SOC. In one illustrative embodiment, the SOC 422 can read the shared memory 470 where details of the program stack for its portioned of the workload reside. In another illustrative embodiment, the SOC 422 can obtain workload (for example, data to be encrypted) via an established communication protocol (e.g., PCI-Express) in which two or more SOCs, e.g., SOC 440 and SOC 422, can communicate with each other. In such an embodiment, each SOC may have a communication core, e.g., (PCIE core), that can be configured as a root or endpoint. When an overloaded SOC is looking to shift work to another SOC, the overloaded SOC may initiated this operation over the communication link, e.g., PCIE link. Assuming a PCIE implementation, the overloaded SOC is the PCIE root, and the SOC to which the workload is to be distributed, i.e. an auxiliary SOC, is the PCIE endpoint. Conversely, when underloading is detected, and there is a need to shift work back to the primary SOC 440 and realize power savings in the auxiliary SOC, e.g., SOC 422, by sending it back to the D3hot state, the auxiliary SOC 422 can send work back to the primary SOC 440 in a similar manner where the roles are reversed, i.e. the auxiliary SOC 422 is the root and the primary SOC 440 is the endpoint.

Thus, once the appropriate SOCs 422-428 in the pool 420 are powered-up, the workload is then distributed over the powered-up SOCs 422-428 thereby offloading the primary SOC 440. The SOCs 422-428, while being general purpose, have cores in them that can handle various types of workloads or which can be configured to process different types of workloads. For example, each SOC 422-428, 440 may contain a cryptographic processing engine to handle encryption/decryption as well as a Graphics Processing Unit (GPU) to handle graphics processing workloads. Thus, in some cases, depending on the particular workload the powered-up SOCs 422-428 may need to be configured with a system image or application image to execute the workload whereas in other cases, the SOCs 422-428 may already comprise the necessary cores, engines, and the like, to perform the processing of the workload.

The powered-up SOCs 422-428, 440 utilize the shared memory 470 to execute their portion of the workload distributed to them such that coherence of the data is maintained, i.e. all of the SOCs 422-428, 440 operate on the same state of the data as stored in the shared memory 470 and thus, coherency mechanisms between the SOCs 422-428, 440 are not needed. The shared memory 470 allows the primary SOC 440 and powered-up SOCs 422-428 to share the state of the workload. For example, if the workload comprises a plurality of sessions between client computing devices and a web site hosted by the platform 410, then the encryption of communications of different sessions may be handled by different ones of the powered-up SOCs 422-428 with the state of each session being maintained in the shared memory 470. Thus, the workload is distributed across the powered-up SOCs 422-428, 440 with state coherency being maintained by the shared memory 470.

While the powered-up SOCs 422-428 are operating on the distributed workload, the analytics monitor 450 continues to monitor the interconnect bus 430 for predetermined conditions, e.g., one or more signals indicative of a predetermined condition, e.g., an overloaded loading condition or underloaded loading condition. If it is determined that the primary SOC 440 continues to be overloaded, additional SOCs 422-428 in the SOC pool 420 may be powered-up through the mechanisms described above so that the workload may be distributed over a larger number of SOCs until the primary SOC 440 is no longer in an overloaded state.

In addition, the analytics monitor 450 may identify a predetermined condition, e.g., one or more signals, events, or data, indicative of the primary SOC 440 entering an underloaded state. For example, the analytics monitor 450 may observe the SOC pin toggling activity between the SOC and the shared memory 470. Under normal conditions, not overloaded or underloaded conditions, the analytics monitor 450 may note what the average SOC pin toggling activity should be. These statistics may be maintained by the analytics monitor 450 and may further determine what condition triggered an overloaded SOC condition, e.g., so many writes and reads within a particular time frame) with subsequent powering-on of a SOC 422-428 from the pool 420. If the SOC pin toggling activity resumes to a level lower than the previously recorded average toggling activity when only a single SOC was in use for a set time, this is detected as indicative of an underloading condition. Internally, within the SOC, the reduced number of address acknowledgements by slave devices over a time frame coupled with a reduced (or no) assertion of particular identifiable signals (sl_rearb, wr_prim, or rd_prim as discussed hereafter) would indicate an underloading condition as well. This may be detected by the internal performance monitors of the SOCs and communicated externally to the analytics monitor 450 via the interconnect bus 430.

In response to the analytics monitor 450 identifying a predetermined condition indicative of an underloaded state of the primary SOC 440, the analytics monitor 450 sends a command/signal to the PRC hardware 460 informing the PRC hardware 460 of the need to power-down one or more of the SOCs 422-428. The PRC hardware 460 initiates redirection of the workload back to the primary SOC 440 and then powers-down the selected one or more SOCs 422-428, or otherwise places them in a low power consumption state, e.g., D3hot state. It should be appreciated that powering down the SOCs 422-428 may be achieved by placing them into a partial power-down or sleep state and maintaining some quiescent power to the powered-down SOCs 422-428. This allows the SOCs 422-428 to be quickly powered-up and deployed versus having to perform a complete power-down that could take a relatively larger amount of time to power-up the SOCs 422-428.

Thus, with the mechanisms of the illustrative embodiments, the analytics monitor 450 continuously monitors the interconnect bus 430 for conditions indicative of overloading and underloading of the platform's primary SOC 440 to determine when to add additional (auxiliary) SOCs 422-428 from the SOC pool 420 and when to free these SOCs 422-428 to maintain a low power consumption state. The SOC pool 420 is essentially a sub-cloud of resources within the platform 410, with the platform 410 being part of the larger cloud computing environment 400 along with other platforms 401-403. In this way, workloads may be sent to the cloud computing environment 400 and routed to the platform 410 which then assigns the workload to the primary SOC 440. In the event that an overload condition is detected by detecting events, data, or signals on the interconnect bus 430, indicative of such an overload condition, SOCs 422-428 from the sub-cloud of the SOC pool 420 are powered-up for distribution of the workload across a plurality of SOCs 422-428. In the event that an underloaded condition is detected by detecting events, data, or signals on the interconnect bus 430, indicative of such an underloaded condition, SOCs 422-428 from the sub-cloud of the SOC pool 420 are powered-down so as to maintain a minimized power consumption state while providing sufficient processing resources to handle the current workload.

As discussed above, each of the SOCs 422-428 and 440 comprises an internal performance monitor that monitors events occurring within the logic of the SOCs 422-428 and 440 and potentially communicates this information to the analytics monitor 450 via the interconnect bus 430. The internal performance monitors may comprise a variety of counters, registers, and tracking logic that track and count the occurrences of these events and the durations of these events. The performance monitors, based on the state of these counters, may issue interrupts and synchronization signals to the analytics monitor that indicates the detected internal loading conditions of the SOC to the analytics monitor 450 for use in determining the loading condition of the SOC. Based on the loading condition of the SOC, the analytics monitor 450 may perform operations to increase/decrease the number of auxiliary SOCs powered-up in the SOC pool 420 to which the workload is distributed and/or route the workload back to the primary SOC 440 or a subset of the SOCs 422-428, 440 less than a previously powered-up number of SOCs, e.g., going back from 3 to 2 to 1 SOCs powered-up as needed.

FIG. 5 is an example block diagram of an SOC that focuses on an example implementation of a performance monitor of the SOC in accordance with one illustrative embodiment. As shown in FIG. 5, the SOC 500 includes the standard elements already discussed above including a microcontroller 510, various cores 520, a memory 530, external bus interface 540, and other timing, peripheral, power, and voltage management logic 550. These elements are standard SOC elements and thus, a more detailed description is not provided herein. It should be appreciated however that in some illustrative embodiments, the cores 520 may comprise various cores configured to perform various operations including cryptographic operations, graphics processing operations, and the like. The memory 530 may be any type of suitable memory including a ROM, EEPROM, flash memory, or the like. The external bus interface 540 provides a communication interface, e.g., signaling pins and the like, for communicating signals and data to an external bus, such as the interconnect bus 430 in FIG. 4. The elements 510-550 are communicatively coupled to one another via the processor local bus (PLB) 505 as well as to the performance monitor 560. It should be noted that the elements 510-550 are only examples of the internal logic elements of the SOC 500 and other elements may be present in addition to, or in replacement of, these depicted elements 510-550 without departing from the spirit and scope of the illustrative embodiments.

The performance monitor 560 monitors the event occurrences and durations encountered by the various elements 510-550. The performance monitor obtains bus signals from the PLB bus 505, slave signals, and master signals which are multiplexed by the multiplexing logic (muxing logic) 566. These signals are output to the corresponding master and slave event counters 572, 576 as well as the duration counters 574 for monitoring the event occurrences and their durations. It should be noted that in this example, the concepts of master and slave devices is utilized where the master is a device that initiates a transaction, such as a processor, Direct Memory Access (DMA) controller, Peripheral Component Interconnect Express (PCIE) controller, or the like. The slave is a device that responds to the transaction initiated by a master, such as a flash memory controller or the like. It should be appreciated that while this example utilizes master and slave signaling, such is not required for implementation of the illustrative embodiments and is only an example of the signaling of events that may occur and may be monitored by a performance monitor of a SOC.

The master event counters 572 count events associated with other devices that are operating as masters within the SOC 500 and counts events associated with certain master device signals, as discussed in greater detail hereafter. The slave event counters 572 count events associated with other devices that are operating as slaves within the SOC 500 and counts events associated with certain slave device signals, as discussed in greater detail hereafter. The duration counters 574 monitor the duration of the events associated with the master and slave devices, or even generic events as monitored by the generic event counters 570. Essentially, the various counters 570-576 count occurrences of events while the duration counters 574 count the duration of the events. The pipeline tracker 562 operates to track pipeline depth events occurring in the pipelined PLB 505. The cycle counter 564 counts processing cycles associated with events.

The control registers 568 store information for communicating interrupts and synchronization signals with the PLB 505. The interrupts and synchronization signals may be transmitted to the analytics monitor 450 via the PLB 505 and external bus interface 540. In this way, the analytics monitor 450 may analyze both internal signals of the SOC 500, as communicated to the analytics monitor 450 via the performance monitor 560, and external signals of the platform 410 as detected on the interconnect bus 430. For example, the analytics monitor 450 may monitor the internal signals of the SOC via the performance monitor 560, unique buffer/FIFO loading signals in the design blocks internal to the SOC via the performance monitor 560, and external signals detected on the interconnect bus 430, such as the external SOC pins between a flash memory controller of the SOC and physical flash memory (e.g., shared memory 470 in FIG. 4).

The occurrence counters 570, 572, and 576 accomplish their counting operations by incrementing their value once for each selected event until a predefined timer has expired at which time the counts may be output to the control registers and/or used to generate interrupts to the analytics monitor 450 and the counters are reinitialized. The duration counters 574 may count the duration via separate registers that increment on every clock cycle (as determined by the cycle counter 564) that a particular event is active. In both cases, a unique interrupt can be sent to the analytics monitor 450 in response to the count reaching a predetermined threshold values, e.g., saturation of the counter, which may be dependent upon the overload/underload conditions being monitored.

The analytics monitor 450 monitors the interconnect bus 430 for specific signals that are indicative of a overloaded condition of the primary SOC 440 or an underloaded condition of the primary SOC 440. To illustrate this further, consider an implementation of the example SOC 500 in FIG. 5 which utilizes a processor local bus in which pipelining related signals are present, such as the IBM 128-bit Processor Local Bus 4 (PLB4) version 4.7, for example. In the PLB4 bus architecture, like many other industry standard bus architectures, synchronous read/write transfers between a master and slave devices attached to the bus are supported. Again, a master device is a device that initiates a transaction, such as a processor, Direct Memory Access (DMA) controller, Peripheral Component Interconnect Express (PCIE) controller, or the like. The slave, as mentioned previously, is a device that responds to the transaction initiated by a master, such as a flash memory controller or the like.

Read and write transactions can be pipelined on the bus 505. In one illustrative embodiment, the PLB4 bus has a pipelining depth for reads of four cycles and for writes, the pipelining depth is two cycles.

When detecting events indicative of overloaded or underloaded conditions of the SOC, various conditions may be monitored for by the analytics monitor 450 based on the interrupt signals and synchronization signals received by the analytics monitor 450 from the performance monitor 560 of the SOC 500. In one illustrative embodiment, if there are a predetermined number of 4 pipeline deep read events in a predetermined interval, e.g., 20 4-deep read pipeline events in 100 ns or less, this may be indicative of an overloading condition of the SOC and a need to distribute the workload to one or more additional SOCs powered-up from the pool 420. In another illustrative embodiment, if there are a predetermined number of 2 pipeline deep write events in a predetermined time interval, e.g., 40 2-deep write pipeline events in 100 ns or less, this may be indicative of an overloading condition of the SOC and a need to distribute the workload to one or more additional SOCs powered-up from the pool 420. In still another illustrative embodiment, both conditions may need to be detected and present in order for workload to be distributed to additional SOCs.

With regard to duration, the duration counters 574 may be used to measure how long a read or write takes (tenure). If the tenures of reads and writes get above (below) a certain threshold that would be indicative of overloading (underloading) of the SOC. For example, if the read tenure of data read by a cryptographic core, one of the cores 520 in FIG. 5, becomes longer (shorter) between 10 or 20 set time intervals, the analytics monitor 450 may make a determination to provision (de-provision) auxiliary SOCs 422-428 from the pool 420. The analytics monitor 450 may obtain this information from the performance monitor 560 which conducts such read and write tenure measurements.

In one illustrative embodiment, using this PLB4 bus architecture, the signals that the analytics monitor 450 looks for on the bus 430 are the PLB primary read request (PLB_RDPRIM) and PLB primary write request (PLB_WRPRIM). The PLB primary read request is asserted by the bus arbiter (not shown) to indicate that a secondary read request that has already been acknowledged by a slave can now be considered a primary read request. Each slave receives its own PLB primary read request signal so that the bus arbiter (or just “arbiter”) can pipeline multiple requests. The arbiter supports second, third, and fourth pipelined transfers and each transfer could be to a unique slave. Similarly, the PLB primary write request is asserted by the arbiter to indicate that a secondary write request can be considered a primary write request in the following clock cycle.

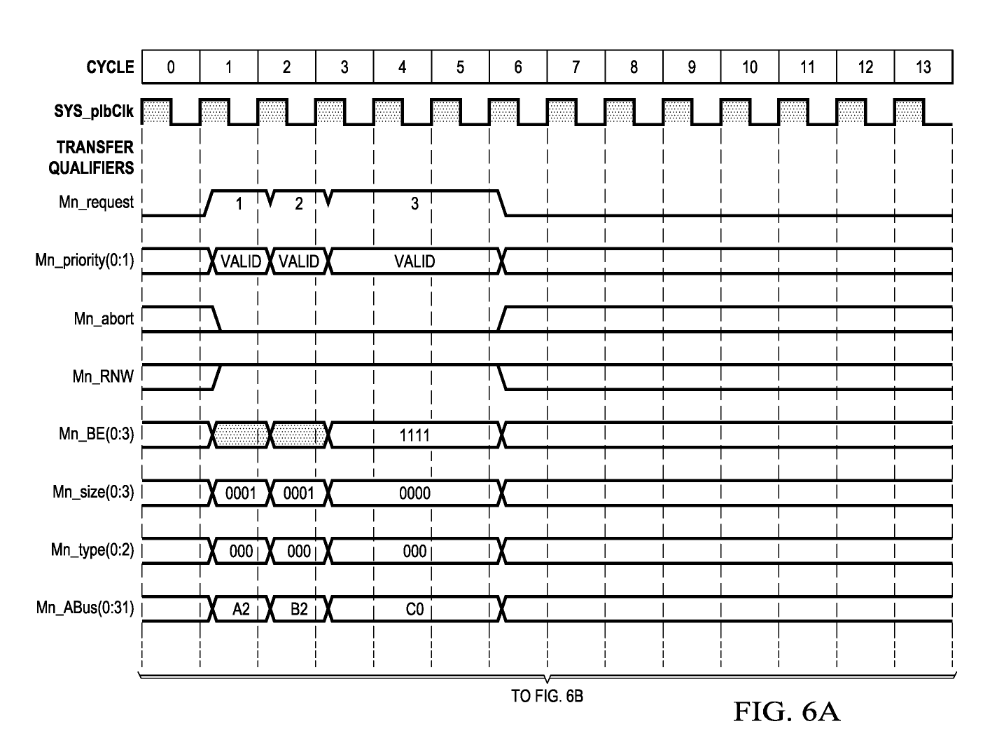

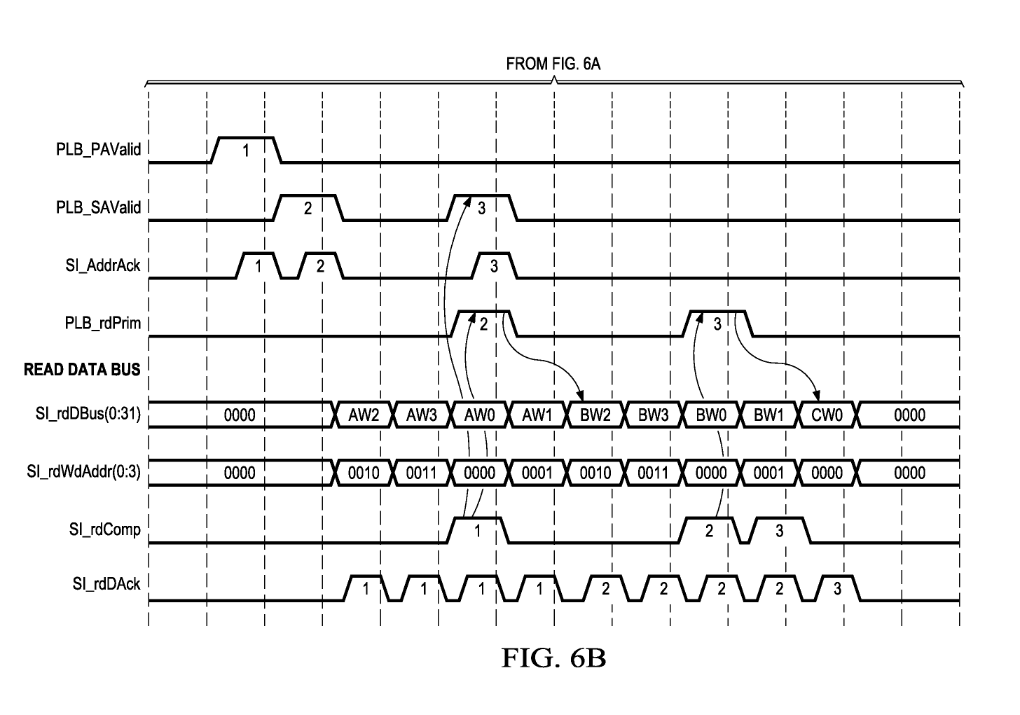

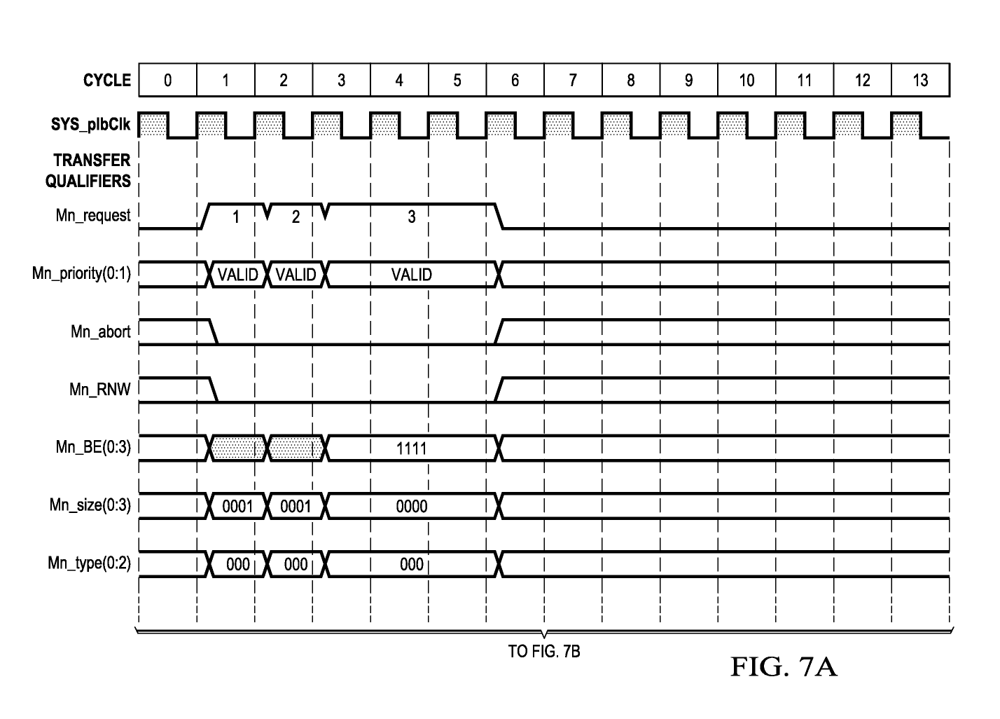

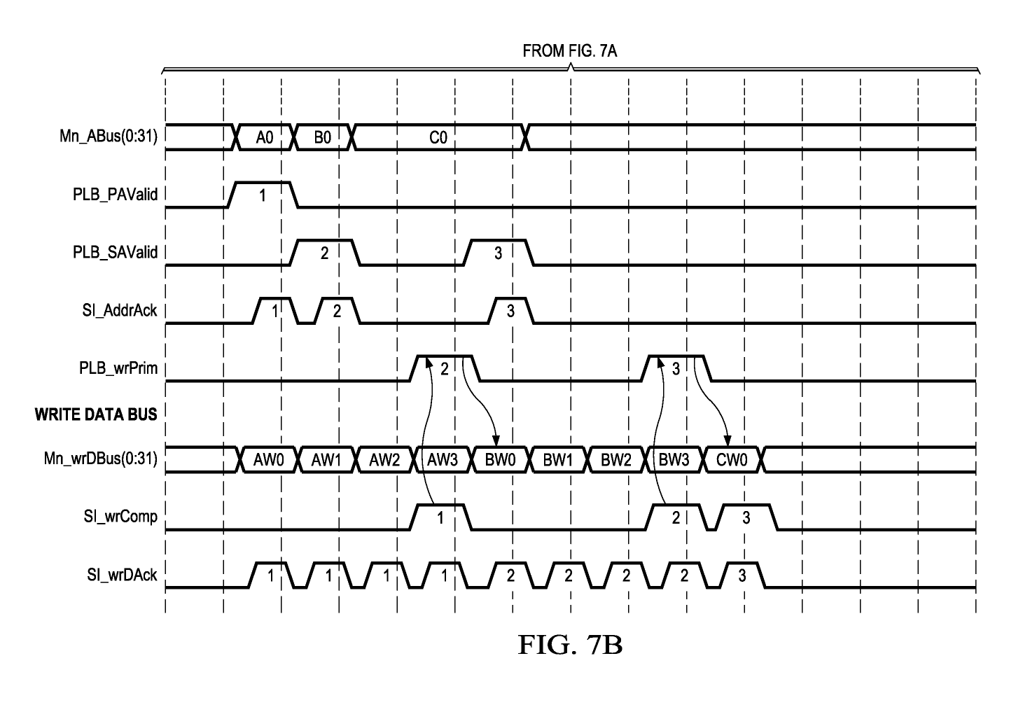

FIGS. 6A-6B illustrate an example timing diagram for a pipelined back-to-back read transfer showing the assertion of a PLB primary read request (PLB_RDPRIM) for which the analytics monitor of the illustrative embodiments monitors. FIGS. 7A-7B illustrate an example timing diagram for a pipelined back-to-back write transfer showing the assertion of the PLB primary write request (PLB_WRPRIM) for which the analytics monitor 450 of the illustrative embodiments monitors. Assertion of these signals (PLB_RDPRIM and PLB_WRPRIM) in a particular pattern within a particular period of time on the PBL 505 of the SOC indicates an overloaded loading condition and the need to “offload” processing to other SOCs, such as SOCs 422-428 of the SOC pool 420. The occurrence of such signals on the PLB 505 may be counted by the various counters 570-576 so as to compare these counts to thresholds or otherwise detect occurrence of the counts reaching some specified threshold, e.g., saturation of the counters, counts equaling or exceeding particular predetermined threshold levels, etc.

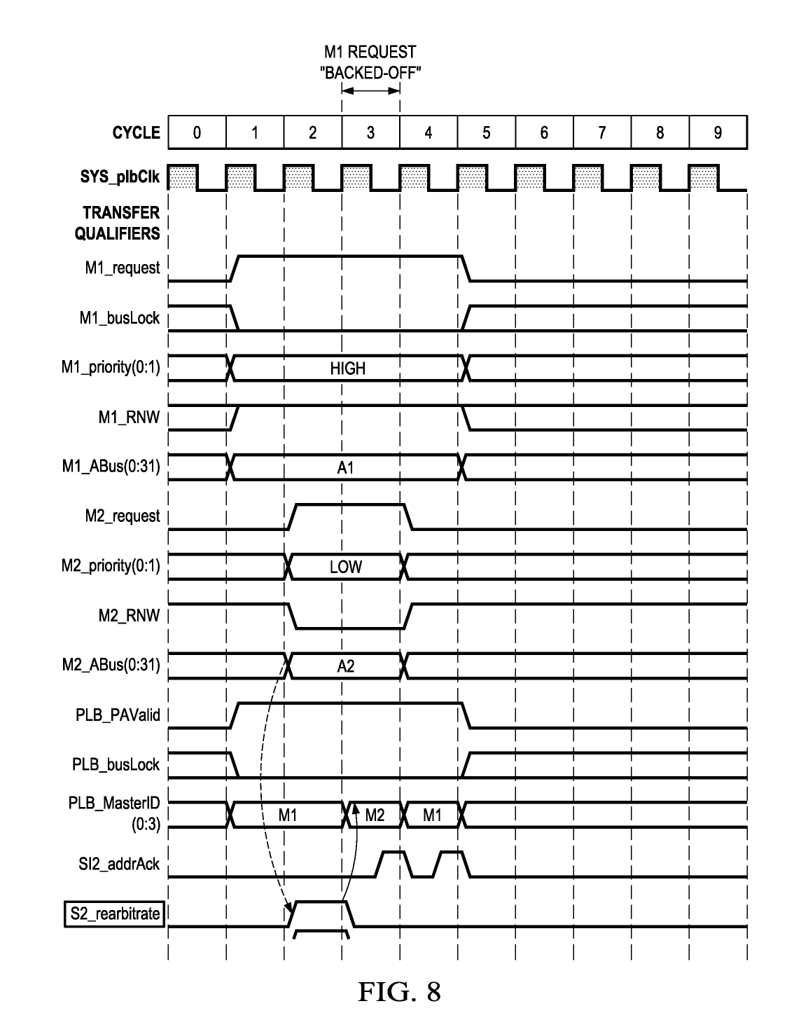

In addition, the analytics monitor 450 may be configured to monitor for other signals indicative of an overloaded or underloaded condition. As an example, if a master attempts to access a slave, for example to read the results of an encryption/decryption operation performed by the slave, and the slave is busy, the slave may issue a slave rearbitrate signal (SL_REARBITRATE) on the bus. This signal is asserted by the slave to indicate that the slave is unable to perform the current read or write (transfer) operation. The reason that the slave may assert this signal is that the slave may be engaged in performing encryption/decryption operations on a large workload such that it is not ready to respond with the results of the operation to the master. This is a clear indication to the analytics monitor 450 that additional SOC resources are needed to handle the workload and assist in reducing the strain on the slave so as to facilitate further encryption/decryption capabilities. Thus, if the analytics monitor 450 detects this signal being asserted multiple times in a set time interval, the analytics monitor 450 may determine that an overload condition exists and may signal the PRC hardware 460 to power-up additional SOCs 422-428 from the SOC pool 420. FIG. 8 illustrates an example timing diagram for a slave requested re-arbitration showing the assertion of a slave re-arbitration signal (S2_REARBITRATE) for which the analytics monitor of the illustrative embodiments monitors.

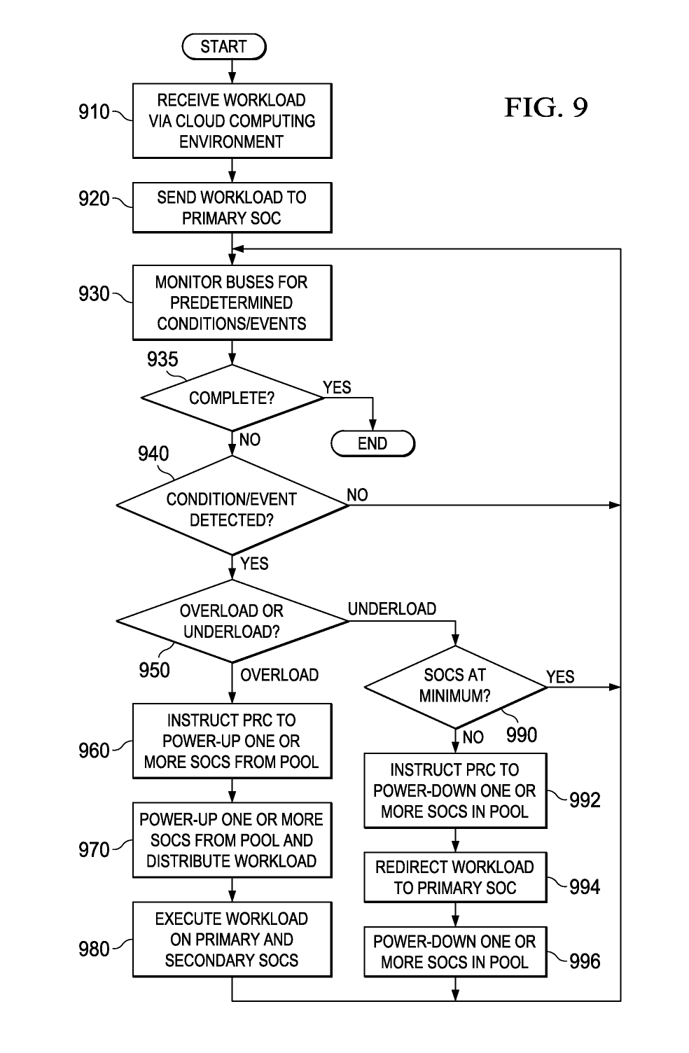

FIG. 9 is a flowchart outlining an example operation for dynamically powering-up and powering-down SOCs from a SOC pool of a sub-cloud in a platform according to workload conditions of the platform in accordance with one illustrative embodiment. The operation outlined in FIG. 9 may be implemented by one or more of the hardware and/or software elements executing on hardware of a platform, such as platform 410 in FIG. 4, as discussed above. In one illustrative embodiment, the operation is performed by a combination of a primary SOC, a pool of SOCs, an analytics monitor, and a PRC hardware element of a platform that operate in conjunction to implement the dynamic powering-up and down of SOCs in a pool of SOCs.

As shown in FIG. 9, the operation starts with receiving a workload via a cloud computing environment, of which the platform is a part, for processing by the platform (step 910). The workload is sent to the primary SOC of the platform for processing (step 920) and the analytics monitor monitors one or more buses associated with the primary SOC for predetermined conditions or events (step 930). As discussed above, the analytics monitor, in one illustrative embodiment, is monitoring for particular signals or patterns of signals asserted on one or more busses which are indicative of an overloaded or underloaded condition of the primary SOC.

A determination is made as to whether the workload has completed execution (step 935). If so, the operation terminates. If not, the operation continues to step 940.

A determination is made as to whether the analytics monitor identifies a predetermined condition/event (step 940). If not, the operation returns to step 930 and continues to monitor for the predetermined conditions. If a predetermined condition is detected by the analytics monitor, a determination is made as to whether the predetermined condition is an overloaded condition or an underloaded condition (step 950). If the operation is an overloaded condition, the analytics monitor communicates with the PRC hardware to power-up one or more SOCs of a pool of SOCs representing the sub-cloud within the platform (step 960). In response to receiving the communication from the analytics monitor, the PRC hardware provisions one or more of the SOCs in the pool of SOCs and distributes the workload across the primary SOC and the one or more SOCs that are now powered-up (step 970). The workload is then executed by the combination of primary SOC and one or more SOCs from the SOC pool (step 980). The operation then returns to step 930 with the analytics monitor continuing to monitor for predetermined events.

If the predetermined event is an underloaded condition, a determination is made as to whether the number of powered-up SOCs is already at a minimum number (step 990). If so, then the operation returns to step 930 with the analytics monitor continuing to monitor for predetermined conditions. If not, the analytics monitor communicates with the PRC hardware to cause the PRC hardware to power-down one or more of the SOCs (step 992). The workload is then redirected back to the primary SOC, or a combination of the primary SOC and SOCs of the SOC pool that are to remain powered-up after the powering-down of the selected SOCs (step 994). The PRC hardware then powers-down the selected SOCs (step 996). The operation then returns to step 930 with the analytics monitor continuing to monitor for predetermined conditions.

Thus, the illustrative embodiments provide mechanisms for utilizing an analytics monitor to monitor conditions identified by events, data, or signals on one or more busses of a platform so as to dynamically power-up or power-down SOCs in a sub-cloud pool of SOCs of the platform to handle workloads submitted through a cloud computing environment to the platform. The mechanisms of the illustrative embodiments allow for the dynamic power-up and powering-down of general purpose SOCs to handle application specific workloads in response to detected overloaded and underloaded conditions of a primary SOC of the platform. In this way, not only does the cloud computing environment provide dynamic allocation of platforms to workloads at a macro level, but the mechanisms of the illustrative embodiments provide for allocation of finer grain resources of the platforms themselves to the handling of the workloads assigned to the platform.

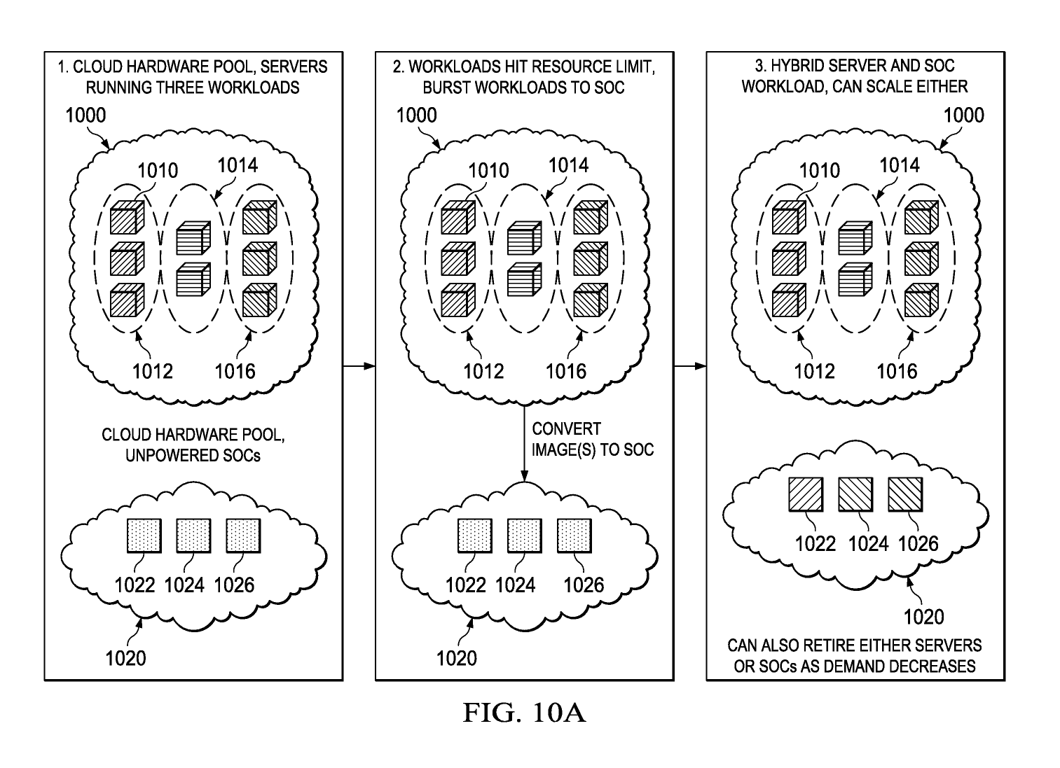

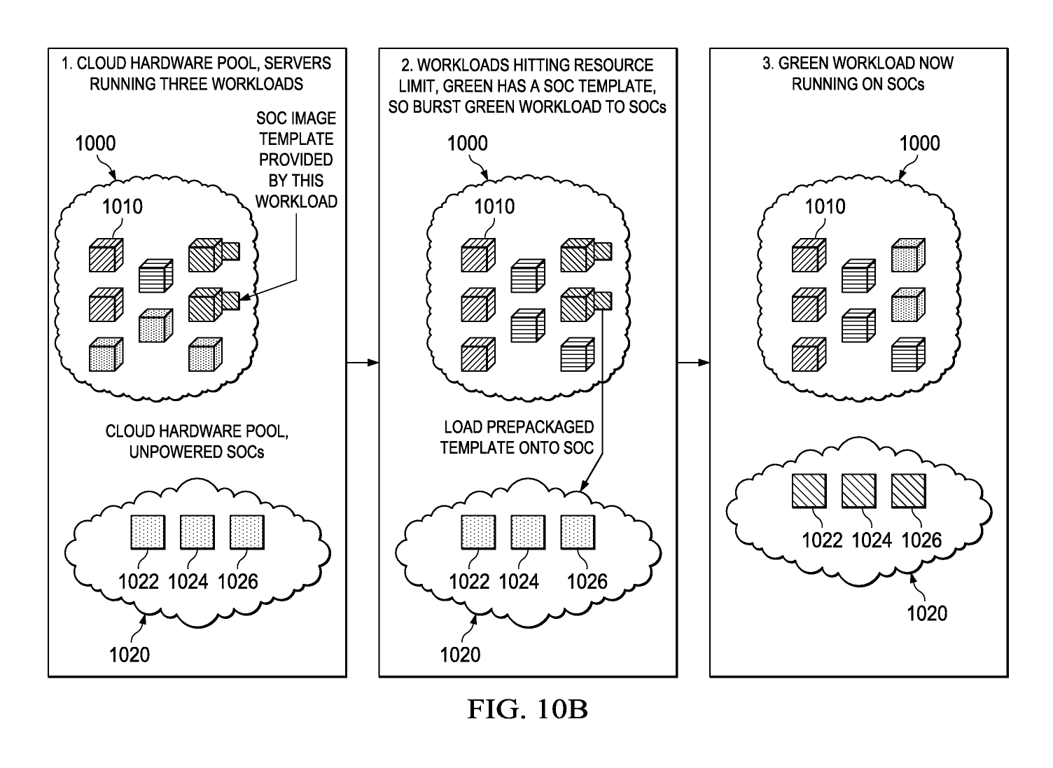

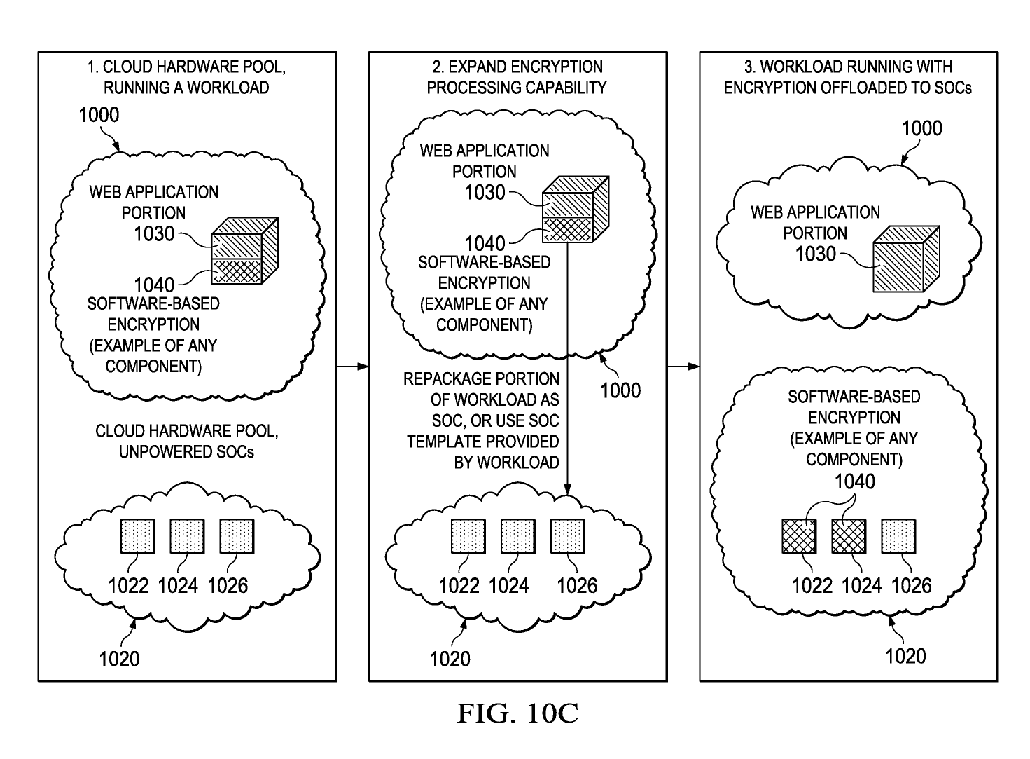

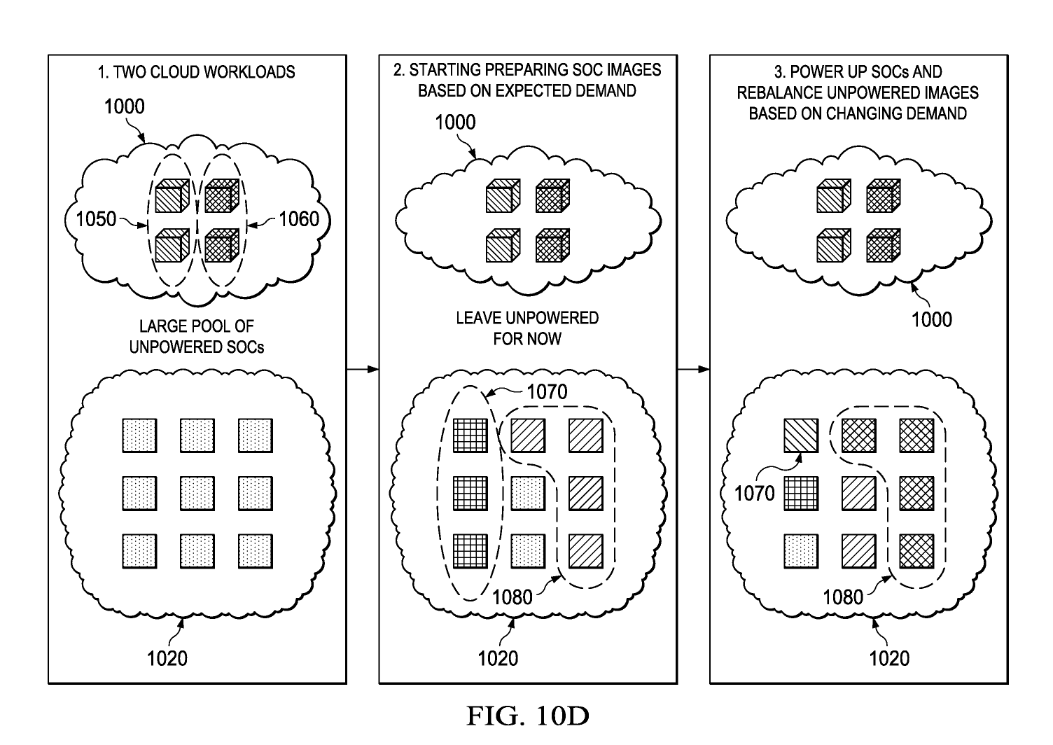

FIG. 10A-10D illustrate example scenarios of the dynamic powering-up and powering-down of SOCs in a pool of SOCs to facilitate workload distribution in accordance with example illustrative embodiments. The mechanisms of the illustrative embodiments facilitate the operation of the cloud computing system as illustrated in FIGS. 10A-10D through the hybrid cloud/sub-cloud resource allocations based on loading conditions of the platforms in the cloud computing system. It should be appreciated that while the cloud computing system is shown as separate from the sub-cloud of general purpose resources, e.g., SOCs, in these example scenarios, this is only for illustrative purposes and the sub-cloud may in fact be part the cloud computing system. In some illustrative embodiments, the sub-cloud may be provided as part of one or more of the platforms of the cloud. In other illustrative embodiments, the sub-cloud may be provided in a sub-set of one or more platforms associated with the cloud computing system and which may operate in conjunction with any of the platforms of the cloud computing system.

It should be appreciated that the cloud system in these examples is comprises of a plurality of servers and/or other platforms that operate to facilitate requests for service from the cloud system. As such, one or more of the servers and/or platforms in the cloud system may be designated as an element of the cloud system that monitors the performance of the cloud system and determines whether the cloud system is overloaded or not, whether there are bursts in traffic to the cloud system, predictions as to whether workloads will likely be needing the use of the pool of the SOCs, or any of the other operations attributed to the cloud system.

The metrics measured by the cloud system may take many different forms depending upon the particular implementation. Advanced cloud platforms will provide controls for auto-scaling and bursting with application response time being the most common metric. An entity that deploys the workload may set a desired response time of between 50-300 ms (for example). When the average response time begins to drift beyond the upper limit, the cloud system may trigger operations to begin taking steps to scale the workload. In accordance with the illustrative embodiments, the scaling can be done using the pool of SOCs. Of course other metrics may include measuring memory actively used by the application, looking at disk space usage, and the like. Essentially any measurable system parameter may be set as the threshold to scale the cloud computing system.

FIG. 10A illustrates a burst scenario in which a burst of traffic is sent to platforms of the cloud computing system. As shown in FIG. 10A, a cloud computing system 1000 comprising a plurality of platforms 1010, which in this example of server computing systems, initially is running three different workloads (represented by different shadings of the blocks 1010 representing the server computing devices). Initially, server computing devices 1012 are running a first workload, servers 1014 are running a second workload, and servers 1016 are running a third workload. The SOCs in the sub-cloud 1020 are initially in a low power-consumption state with the exception of a primary SOC which may be maintained in a powered-up state so that it may be an initial responder to workload offloading from the cloud computing system 1000.

At a later time, a burst of one or more of the workloads is received by the server computing devices 1012 and 1016. As a result, an image of the workload is generated loaded into the shared memory (not shown) of the sub-cloud 1020 for execution by one or more of the SOCs in the sub-cloud 1020. SOCs in the sub-cloud 1020 are provisioned to run this workload image in the manner previously described above. This may involve allocating the workload to primary SOC 1022 for execution with subsequent scaling up/down the number of SOCs associated with particular workloads based on the loading conditions of the SOCs. Thus, for example, as the workload increases for one workload, the number of SOCs powered-up and executing that workload may be increased, e.g., SOCs 1024-1026 may be powered-up with the workload being distributed over the additional SOCs 1024-1026.

The SOCs 1022-1026 of the sub-cloud 1020 are general purpose SOCs 1022-1026 that are capable of handling any of the workloads running on the servers 1010. The SOCs 1022-1026 may comprise cores configured to run the various workloads and/or may be configured with operating system images, application images, or the like, to handle the various workloads. Thus, as opposed to known cloud computing systems, in this scenario additional workload capacity is provided by SOCs of a sub-cloud 1020 of one or more platforms which run SOC images of the workload. The term “SOC image” refers to a system image comprising a light-weight version of an operating system, application instance(s), and data, that is run on an SOC.

It should be appreciated that, in some illustrative embodiments, the system image, application image, and the like for use in processing workloads may be pre-loaded into the SOCs 1022-1026 of the sub-cloud 1020. The SOCs 1022-1026, while pre-loaded with the system image, application image, or the like, may remain in a low power state or powered-off state. Thus, the SOCs 1022-1026 are prepared ahead of time to accept workloads should a workload burst be encountered. In so doing, the provisioning time and preparation effort required to set up the SOCs 1022-1026 for execution of workloads is minimized when a workload burst is encountered. In this situation, when the cloud computing system 1020 sees the servers 1010 of the cloud computing system 1000 approaching their capacity to handle the workload, these system images, application images, and the like may be moved to the SOCs 1022-1026 in preparation for offloading workloads to the SOCs 1022-1026 of the sub-cloud while keeping the SOCs 1022-1026 in a low power consumption or powered-off state until needed.

FIG. 10B is an example scenario in which the servers of the cloud computing system include a SOC image template for the workloads that they execute that may be used to load the SOCs of the sub-cloud 1020 with the workload when a workload burst is encountered. This scenario is similar to that of FIG. 10A with the exception that in this case the workload associated with servers 1016 comprises a pre-packaged SOC system image along with its software deployment as a SOC template. This SOC template can be registered with the cloud system 1000 so that the cloud system 1000 knows which workloads have a SOC image readily available. The SOC image template (or SOC template) is a SOC system image, but which may differ from the application server program itself. For example, the server workload may generally be an application running on Linux with x86 hardware, whereas the bundled template may be a very similar Linux image but the binary code could be compiled for a non-x86 hardware architecture as used by the SOCs. Thus, the workload built to run on a SOC may have differences from the workload built to run on a traditional cloud computing system server, and, in some illustrative embodiments, the cloud workload bundles the SOC version of itself for when it is needed.

When the servers 1010 are running out of capacity, the cloud system 1000 selects the workload that has the SOC templates already available and loads this template onto one or more of the powered-up SOCs 1022-1026 of the sub-cloud 1020, powered-up in the manner previously described above. Thus, while the burst may be associated with the workload on servers 1012, since the registered workload template is associated with the workload on servers 1016, it is this workload on servers 1016 that may be migrated to the sub-cloud 1020.

In the depicted example, the workload of servers 1016 is distributed across the SOCs 1022-1026 in the manner previously described by loading the SOCs 1022-1026 with the pre-packaged SOC template for that workload. As a result, the servers previously running the workload 1016 are freed to execute other workloads. In the depicted example, the servers previously running the workload 1016 are then used to execute the workload 1012.

FIG. 10C is an example scenario in which partial selective workload offloading is performed using the mechanisms of the illustrative embodiments. In this scenario, the servers of the cloud computing system 1000 execute a web application workload 1030 and a software-based encryption workload 1040. The web application workload 1030 and software-based encryption workload 1040 may, in other illustrative embodiments, be any suitable application workloads. Initially, the SOCs of the sub-cloud 1020 are in a powered-down or low power consumption state, again other than the primary SOC.

In this scenario, through the mechanisms of the illustrative embodiments, only a portion of the workloads 1030 and 1040 is offloaded to the SOCs 1022-1026 of the sub-cloud 1020. For example, software based encryption workloads 1040, such as SSL workloads, may be offloaded to the SOCs 1022-1026 since hardware-based accelerators may be available in the SOCs 1022-1026 and the workload 1040 may be componentized easily for offload. However, in this scenario, the encryption workload 1040 is not sent to a dedicated encryption hardware of the servers in the cloud computing system 1000, but rather is directed to the general purpose SOCs 1022-1026 of the sub-cloud 1020.

Thus, as shown in FIG. 10C, the encryption workload 1040 is repackaged as an SOC image, or uses the SOC template mechanism of FIG. 10B to configure the SOCs 1022-1026 of the sub-cloud 1020 with a SOC template provided as part of the workload 1030 to perform the workload 1040. As a result, SOCs 1022-1024 of the sub-cloud 1020 execute the workload 1040 which frees the servers 1010 of the cloud computing system 1000 to run the other workloads, e.g., workload 1030.

FIG. 10D is an example scenario in which workload predictions are utilized to determine which workload system images, or templates, to pre-load onto the SOCs in preparation for potential overloaded conditions of the servers 1010 of the cloud computing system 1000. As shown in FIG. 10D, the servers 1010 of the cloud computing system 1000 initially are executing various workloads 1050, 1060 while the pool of SOCs in the sub-cloud 1020 are in a low power consumption state or powered-off (again with the exception of a primary SOC). Prediction mechanisms of the cloud computing system may be utilized to predict, based on the current processing state of the workloads 1050, 1060, which if any of the workloads are approaching a maximum capacity of the servers 1010, thereby predicting which of the workloads 1050, 1060 are likely to require additional resources from the sub-cloud 1020.

For example, the current server resource usage (CPU, storage, bandwidth, etc.) may be monitored to determine if the current server resource usage meets or exceeds a first threshold indicative of a likelihood that the workload will reach the maximum capacity of the servers executing the workload. If so, then a prediction that the workload will require additional resources from the sub-cloud 1020 is made and a process is initiated to preemptively install a workload system image or SOC template into one or more of the SOCs of the sub-cloud 1020. The determination as to how many SOCs of the sub-cloud to preemptively install a workload system image or SOC template on for each workload may be based on growth analysis of the workload. In some illustrative embodiments, the decision of which SOCs to put a particular workload on would come down to a combination of the SOCs available, expected need by the workload for those SOCs, opportunity cost to install the system image or SOC template on the SOC, and contention for those SOCs by multiple workloads (prioritizing).

In the depicted example, subset 1070 of the SOCs is preemptively loaded with a workload system image or SOC template corresponding to workload 1050 while subset 1080 of the SOCs is preemptively loaded with a workload system image or SOC template corresponding to workload 1060. While the SOCs are preemptively loaded in this manner, the SOCs remain in a low power consumption state or powered-off state until such time as they are required to assist with processing the workloads due to an overload condition of one or more of the servers 1010 in the cloud computing system 1000.

The workload conditions of the servers 1010 are continually monitored to determine if the workload current processing state has reached a maximum capacity of the servers 1010 in which case the above mechanisms for powering-up SOCs in the sub-cloud 1020 is followed with the workload being distributed across the powered-up SOCs. The SOCs that are powered-up are initially the ones that were pre-loaded with a workload system image or SOC template corresponding to the workload being executed by the overloaded servers 1010. As a result, the offloading of the workload is made less time consuming since the SOCs are already configured to execute the workload. The workload predictions may again be made so as to determine which, if any of the remaining powered-down or low power-state SOCs should be pre-loaded with the workload system image or SOC template based on a prediction of which workloads are likely to become overloaded, or remain overloaded.

Thus, with the implementation of the mechanisms of the illustrative embodiments, a pool of general purpose resources, such as general purpose SOCs, may be provided in a low-power consumption state, which may then be dynamically allocated to execution of cloud computing system workloads in response to a determination that one or more of the computing devices in the cloud computing system have become overloaded. In addition, these SOCs may be pre-configured with system images or SOC images that configure the SOCs for specific workloads while maintaining the SOCs in a powered-down state until an overloaded condition of the one or more computing devices is detected. This pre-configuring of the SOCs may be done based on predictions as to which workloads are likely going to need additional resources, as determined from current processing state metrics of the computing devices. These mechanisms may be utilized with multiple different workloads being handled by the cloud computing system such that some SOCs may execute a first workload while others execute another workload. The workloads that are offloaded to the SOCs may be selected based on criteria indicative of an ease of distribution of the workload over a large number of computing devices/SOCs. Moreover, as discussed at length above, analytics monitoring within the platform providing the SOCs may be utilized to monitor bus communications from the powered-up SOCs to monitor their operating conditions to dynamically power-up/power-down the SOCs as needed to facilitate processing the workloads while maintaining minimum power consumption.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1-10. (canceled)

11. A computer program product comprising a computer readable storage medium having a computer readable program stored therein, wherein the computer readable program, when executed on a data processing system comprising a primary system on a chip (SOC) and a pool of SOCs, causes the data processing system to:
receive a cloud computing workload submitted to a cloud computing system with which the data processing system is associated;
allocate the cloud computing workload to the primary SOC;
monitor, by an analytics monitor of the data processing system, a bus of the data processing system for at least one first signal indicative of an overloaded condition of the primary SOC;
power-up, by a Power, Reset, and Clocking (PRC) hardware block, one or more auxiliary SOCs in the pool of SOCs in response to the analytics monitor detecting the at least one first signal;
distribute the workload across the primary SOC and the one or more auxiliary SOCs in response to powering-up the one or more SOCs; and
execute the workload by the primary SOC and the one or more SOCs.

12. The computer program product of claim 11, wherein the computer readable program further causes the data processing system to allocate the cloud computing workload to the primary SOC at least by storing the cloud computing workload in a shared memory of the pool of SOCs, and wherein each SOC in the pool of SOCs shares the shared memory to thereby maintain coherency of the cloud computing workload.

13. The computer program product of claim 11, wherein the computer readable program further causes the data processing system to monitor the bus of the data processing system at least by monitoring signaling pins of the one or more auxiliary SOCs in the pool of SOCs for signals transmitted by internal performance monitors of the one or more auxiliary SOCs.

14. The computer program product of claim 12, wherein the computer readable program further causes the data processing system to monitor the bus of the data processing system for at least one first signal indicative of an overloaded condition of the primary SOC at least by monitoring the bus for a pattern of first signals comprising signals indicative of at least one of a number of read operations within a predetermined time period, a number of write operations to the shared memory occurring within the predetermined time period, or occurrence of one or more rearbitration signals.

15. The computer program product of claim 11, wherein the computer readable program further causes the data processing system to:
transmit, by the analytics monitor, an interrupt to the PRC hardware block in response to the analytics monitor detecting the at least one first signal indicative of an overloaded condition of the primary SOC, wherein the powering-up of the one or more auxiliary SOCs is performed by the PRC hardware block in response to receiving the interrupt from the analytics monitor.

16. The computer program product of claim 11, wherein the computer readable program further causes the data processing system to:
monitor, by the analytics monitor, the bus of the data processing system for at least one second signal indicative of an underloaded condition of one or more of the auxiliary SOCs; and
power-down, by the PRC hardware block, at least one of the one or more auxiliary SOCs in response to the analytics monitor detecting the at least one second signal.

17. The computer program product of claim 11, wherein the cloud computing system executes a plurality of workloads, and wherein the computer readable program further causes the data processing system to:
predict which workloads of the plurality of workloads are likely to result in an overloaded condition of the cloud computing system; and
in response to results of the predicting, pre-load one or more of the SOCs in the pool of SOCs with one of a system image or a SOC image corresponding to workloads predicted to be likely to result in an overloaded condition of the cloud computing system.

18. The computer program product of claim 17, wherein the workloads comprise an SOC image for offloading the workload to one or more SOCs of the pool of the SOCs, and wherein the computer readable program further causes the data processing system to pre-load one or more of the SOCs in the pool of SOCs at least by pre-loading the SOC with an SOC image corresponding to the workloads predicted to be likely to result in an overloaded condition of the cloud computing system.

19. The computer program product of claim 11, wherein the primary SOC is a SOC in the pool of SOCs that remains powered-up while other SOCs in the pool of SOCs are placed in a low power consumption state, and is initially loaded with workloads when they are submitted to the data processing system prior to other SOCs in the pool of SOCs.

20. An apparatus comprising:
a primary system on a chip (SOC);
a pool of SOCs;
an analytics monitor;
a Power, Reset, and Clocking (PRC) hardware block; and
an interconnect bus coupling the primary SOC, pool of SOCs, and analytics monitor to one another, wherein the apparatus is configured to:
receive a cloud computing workload submitted to a cloud computing system with which the data processing system is associated;
allocate the cloud computing workload to the primary SOC;
monitor, by the analytics monitor of the data processing system, a bus of the data processing system for at least one first signal indicative of an overloaded condition of the primary SOC;
power-up, by the PRC hardware block, one or more auxiliary SOCs in the pool of SOCs in response to the analytics monitor detecting the at least one first signal;
distribute the workload across the primary SOC and the one or more auxiliary SOCs in response to powering-up the one or more SOCs; and
execute the workload by the primary SOC and the one or more SOCs.
